(19) United States
(12) Patent Application Publication
(10) Pub. No.: US 2008/0036698 A1
(43) Pub. Date: Feb. 14, 2008

(54) Display

(76) Inventors: Masahiro Kawasaki, Tsukuba (JP); Masahiko Ando, Hitachinaka (JP); Takeo Shiba, Kodaira (JP); Shuji Imazeki, Hitachi (JP); Masaaki Fujimori, Hitachi (JP); Hideyuki Matsuoka, Nishitokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/834,736

(22) Filed: Aug. 7, 2007

(30) Foreign Application Priority Data
Aug. 9, 2006 (JP) 2006-216368

(51) Int. Cl. G09G 3/20

(52) U.S. Cl. 345/55

(57) ABSTRACT

A display arranged with, in a matrix way, signal lines for providing brightness information to each of pixels, and scanning lines for selecting, in a predetermined cycle, pixels to be provided with brightness information; intake of the brightness information to each of the pixels being executed by intake of signal voltage of the signal lines via thin-film transistors in each of said pixels, in selecting the scanning lines connected with each of the pixels; and having pixels of n-lines and m-rows, by which the brightness information taken into each of the pixels is retained by capacity thereof, even after the scanning lines connected with each of the pixels become a non-selection state, wherein each of the pixels of each line is provided with at least one semiconductor layer that is common between each of the pixels, and the semiconductor layer is formed in parallel to said signal lines.

### BACKGROUND OF THE INVENTION

The present invention relates to a display using a thin-film transistor, and a production method for the thin-film transistor.

With progress of information-oriented society, development of a thin and light electronic paper display or an IC tag which is capable of instantaneously discriminating goods one by one, or the like, as substitution for paper, has been noticed. At present, a thin-film transistor (TFT), wherein amorphous silicon (a-Si) or polycrystalline silicon (p-Si) is used as a semiconductor, is used as a switching element for these devices. However, production of a TFT using theses silicon-based semiconductors has a problem of not only high production cost because of requiring an expensive apparatus for plasma chemical vapor deposition (CVD) or a sputtering apparatus or the like, but also low throughput because it is required to be produced via many processes such as a vacuum process, photolithography, fabrication or the like.

Under these circumstances, a printed TFT is noticed, where members such as semiconductor, wiring and electrode, insulating film are formed by direct pattern fabrication, using screen printing, micro-printing, ink-jet or the like. These printing methods are expected to have advantage of less production steps as compared with a photolithography step because a material necessary is arranged and formed at only required position, and also advantage of cheap formation of an electrode substrate, due to high utilization efficiency of a material. JP-A-2005-513818 introduces a formation example of a TFT with a channel length of 5 μm or less, by an ink-jet method, as a formation example of a fine electrode pattern using a printing method.

In addition, a thin-film transistor using the above-described electrode substrate is utilized in an active matrix drive type display, and also used in a display of such as a personal computer, a mobile phone, a flat TV or the like, wherein, for example, a liquid crystal element, an organic electroluminescence element, an electrophoresis element or the like is used as a display element. In addition, there is a movement to utilize the above-described thin-film transistor as RFID represented by a non-contact IC card or the like, as a non-contact information medium, or a sensor.

### SUMMARY OF THE INVENTION

However, in using a substrate with high thermal expansion coefficient such as light and thin polymer or the like, screen printing or micro-printing utilizing a mold has a problem of generation of matching displacement in transcription of finely shaped member from a printing apparatus onto a substrate. In addition, ink-jet has a problem of being not capable of attaining high precision due to generation of pattern displacement caused by displacement of a scattering direction of liquid droplets by change in wetting conditions of a nozzle. Furthermore, there is a problem of frequent generation of nozzle clogging depending on a solution to be used.

It is an object of the present invention to prevent pattern displacement, which generates in direct pattern fabrication of a semiconductor layer, or nozzle clogging, and to provide a high precision and high performance display.

To attain the above-described object, the present invention is configured by an active matrix type display having a plurality of signal lines, a plurality of scanning lines arranged orthogonally to a plurality of signal lines, a plurality of pixels enclosed by a plurality of signal lines and a plurality of scanning lines and thin-film transistors arranged at each of a plurality of pixels, and having a plurality of pixels arranged in a matrix state, wherein the thin-film transistors have a substrate, a gate electrode, a gate insulating film, a source electrode and a drain electrode, and a semiconductor layer; and the semiconductor layer is arranged over a plurality of pixels, and in parallel to the signal lines and linearly.

In addition, the present invention is configured by an active matrix type display having a plurality of signal lines, a plurality of scanning lines arranged orthogonally to a plurality of signal lines, a plurality of pixels enclosed by a plurality of signal lines and a plurality of scanning lines, and thin-film transistors arranged at each of a plurality of pixels, and having a plurality of pixels arranged in a matrix state, wherein the thin-film transistors have a substrate, a gate electrode, a gate insulating film, a source electrode and a drain electrode, and a semiconductor layer; and the semiconductor layer is arranged over a plurality of pixels, and in parallel to the scanning lines and linearly.

Further, the present invention is configured by an active matrix type display having a plurality of signal lines, a plurality of scanning lines arranged crosswise with a plurality of signal lines, a plurality of pixels enclosed by a plurality of signal lines and a plurality of scanning lines, and thin-film transistors arranged at each of a plurality of pixels, and having a plurality of pixels arranged in a matrix state, wherein the thin-film transistors have a substrate, a gate electrode, a gate insulating film, a source electrode and a drain electrode, and a semiconductor layer; having two partition walls arranged onto each of the source electrode and the drain electrode or the gate insulating film, and arranged in parallel to the signal lines and linearly; and the semiconductor layer is arranged between the two partition walls, over a plurality of pixels, and in parallel to the signal lines and linearly.

Pattern displacement, which generates in direct pattern fabrication of a semiconductor layer, or nozzle clogging, can be prevented, and a high precision and high performance display can be provided.

Other objects, features and advantages of the invention will become apparent from the following description of the embodiments of the invention taken in conjunction with the accompanying drawings.

### BRIEF DESCRIPTION OF THE DRAWINGS

FIG. 1 is a drawing showing one plan view structure example of an equivalent circuit and a pixel part of a display relevant to the present invention.

FIG. 2 is a drawing showing other plan view structure example of a pixel part of a display relevant to the present invention.

FIG. 3 is a drawing showing other plan view structure example of a pixel part of a display relevant to the present invention.

FIG. 4 is a drawing showing other plan view structure example of a pixel part of a display relevant to the present invention.

FIG. 5 is a drawing showing other plan view structure example of a pixel part of a display relevant to the present invention.

FIG. 6 is a drawing showing other plan view structure example of a pixel part of a display relevant to the present invention.

FIG. 7 is a drawing showing one cross-sectional structure example of a thin-film transistor of FIG. 1 and FIG. 2 of the present invention.

FIG. 8 is a drawing showing one cross-sectional structure example of a thin-film transistor of FIG. 5 of the present invention.

FIG. 9 is a drawing showing other cross-sectional structure example of a thin-film transistor of the present invention.

FIG. 10 is a drawing showing other cross-sectional structure example of a thin-film transistor of the present invention.

FIG. 11 is a drawing showing other cross-sectional structure example of a thin-film transistor of the present invention.

FIG. 12 is a drawing showing other cross-sectional structure example of a thin-film transistor of the present invention.

FIG. 13 is a drawing showing other plan view structure example of a display relevant to the present invention.

FIG. 14 is a drawing showing other plan view structure example of pixel part of a display relevant to the present invention.

FIG. 15 is a drawing showing one plan view structure example of pixel part of a display relevant to the present invention.

FIG. 16 is a drawing showing one plan view structure example of pixel part of a display relevant to the present invention.

FIG. 17 is a drawing showing other plan view structure example of pixel part of a display relevant to the present invention.

FIG. 18 is a drawing showing other plan view structure example of pixel part of a display relevant to the present invention.

FIG. 19 is a drawing showing other plan view structure example of pixel part of a display relevant to the present invention.

FIG. 20 is a drawing showing other plan view structure example of pixel part of a display relevant to the present invention.

FIG. 21 is a drawing showing a plan view structure example where a pixel part of a display relevant to the present invention is arranged in a matrix way.

### DETAILED DESCRIPTION OF THE INVENTION

Embodiments of the present invention will be explained in detail below with reference to drawings.

### Embodiment 1

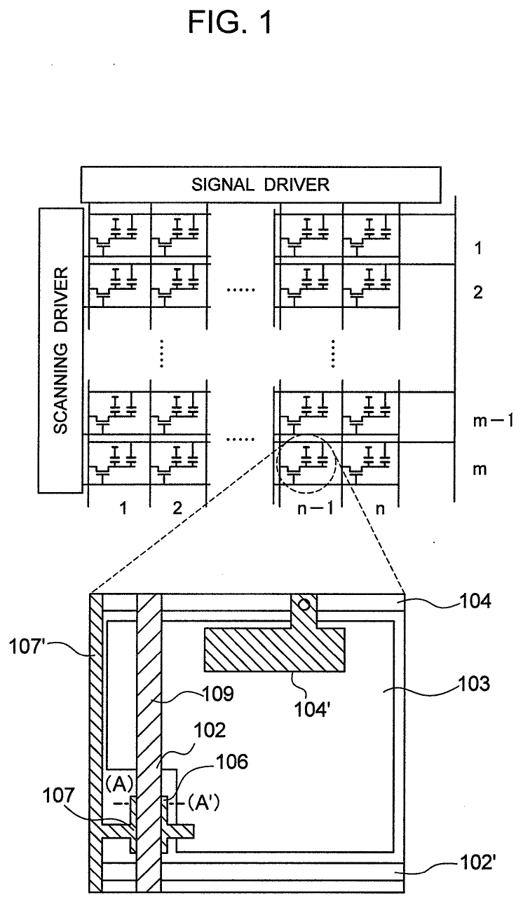

A first embodiment of the present invention will be explained with reference to FIG. 1 to FIG. 12 and FIG. 21.

As the insulating substrate 101, a substrate that is composed of polyethylene terephthalate provided with a barrier film of 100 nm thick SiO₂ at the both surfaces of the substrate was used. As the insulating substrate 101, any material can be selected from a wide range as long as it is an insulating material. Specifically, an inorganic substrate of such as glass, quartz, sapphire, silicon or the like; and an organic plastic substrate of such as acryl, epoxy, polyamide, polycarbonate, polyimide, polynorbornene, polyphenylene oxide, polyethylene naphthalenedicarboxylate, polyethylene naphthalate, polyallylate, polyether ketone, polyether sulphone, polyketone, polyphenylene sulfide or the like can be used.

In addition, those provided with a film of such as silicon oxide, silicon nitride or the like at the surface of these substrates may be used. The gate electrode 102 and the scanning line 102′, the pixel electrode 103, and the common wiring 104 are formed thereon at the same layer with a thickness of 150 nm by IZO (indium zinc oxide), using a photolithography method. The gate electrode 102 and the scanning line 102′, the pixel electrode 103, and the common wiring 104 are not especially limited as long as being electric conductors, and for example, they can be formed by a known method such as a plasma CVD method, a thermal vapor deposition method, a sputtering method, a screen printing method, an ink-jet method, an electrolytic polymerization method, an electroless plating method, an electric plating method, a hot stamping method or the like, using not only a metal such as Al, Cu, Ti, Cr. Au, Ag, Ni, Pd. Pt. Ta or the like, but also a silicon material such as monocrystalline silicon and polycrystalline silicon, a transparent electric conductor such as ITO (indium tin oxide) and tin oxide, or an organic electric conductor such as polyaniline or poly(3,4-ethylenedioxythiophene)/polystyrenesulfonate.

The above-described gate electrode may be used as not only a single layer structure but also a structure laminated with a plurality of layers such as a lamination of a Cr layer and an Au layer, or a lamination of a Ti layer and a Pt layer, or the like. In addition, the above-described gate electrode 102, the scanning line 102′, the pixel electrode 103 and the common wiring 104 are fabricated to a desired shape using a photolithography method, a shadow mask method, a micro-printing method, a laser abrasion method or the like.

Then, a SiO₂ film with a thickness of 300 nm was formed by firing at 120° C., after spin coating of a polysilazane solution, and the SiO₂ films at a part on the common wiring 104 and on the pixel electrode 103 were removed to form the gate insulating film 105. The gate insulating film 105 can be formed using an inorganic film of such as silicon nitride, aluminum oxide, tantalum oxide or the like; an organic film of such as polyvinylphenol, polyvinyl alcohol, polyimide, polyamide, parylene, polymethylmethacrylate, polyvinyl chloride, polyacrylonitrile, poly(perfluoroethylene-co-butenyl vinyl ether), polyisobutylene, poly(4-methyl-1-pentene), poly(propylene-co-(1-butene)), a benzocyclobutene resin or the like; or a laminated film thereof, by a plasma CVD method, a thermal vapor deposition method, a sputtering method, an anodic oxidation method, a spraying method, a spin coating method, a roll coating method, a blade coating method, a doctor roll method, a screen printing method, a nano-printing method, an ink-jet method or the like. Then, the Au source electrode 106, the drain electrode 107, the signal line 107′ and the supporting electrode 104′ were formed in a thickness of 50 nm.

A material of the source electrode 106, the drain electrode 107, the signal line 107′, and the supporting electrode 104″ are not especially limited as long as being electric conductors, and for example, they can be formed by a known method such as a plasma CVD method, a thermal vapor deposition method, a sputtering method, a screen printing method, an ink-jet method, an electrolytic polymerization method, an electroless plating method, an electric plating method, a hot stamping method or the like, using not only a metal such as Al, Cu, Ti, Cr, Au, Ag, Ni, Pd, Pt, Ta or the like, but also a transparent electric conductor such as ITO and tin oxide, or an organic electric conductor such as polyaniline or poly(3,4-ethylenedioxythiophene)/polystyrenesulfonate.

The above-described source electrode and the drain electrode may be used as not only a single layer structure but also a structure laminated with a plurality of layers. In addition, the above-described source/drain electrodes are fabricated to a desired shape using a photolithography method, a shadow mask method, a micro-printing method, a laser abrasion method or the like.

Then, the upper part of the above-described gate insulating film was modified with the monomolecular film 108 of hexamethyldisilazane. As the monomolecular film, a silane-based compound such as heptafluoroisopropoxypropylmethyldichlorosilane, trifluoropropylmethyldichlorosilane, octadecyltrichlorosilane, vinyltriethoxysilane, γ-methacryloxypropyltrimethoxysilane, γ-aminopropyltriethoxysilane, N-phenyl-γ-aminopropyltrimethoxysilane, γ-mercaptopropyltrimethoxysilane, heptadecafuluoro-1,1,2,2-tetrahydrodecyl-1-trimethoxysilane, octadecyltriethoxysilane, decyltrichlorosilane, decyltriethoxysilane, phenyltrichlorosilane, or the like; or a phosphonic acid-based compound such as 1-phosphonooctane, 1-phosphonohexane, 1-phosphonohexadecane, 1-phosphono-3,7,11,15-tetramethylhexadecane, 1-phosphono-2-ethylhexane, 1-phosphono-2,4,4-trimethylpentane, 1-phosphono-3,5,5-trimethylhexane or the like may be used. The above modification can be attained by subjecting the surface of the gate insulating film to contact with a solution or vapor of the above compounds, so that the above compounds are adsorbed onto the surface of the gate insulating film. In addition, the surface of the gate insulating film may not be modified with the monomolecular film 108.

Then, a soluble pentacene derivative was continuously coated with a nozzle jet apparatus and fired at 100° C. to form the semiconductor layer 109 with a thickness of 100 nm. The semiconductor layer 109 can be formed using a phthalocyanine-based compound such as copper phthalocyanine, ruthenium bisphthalocyanine and aluminumchloride phthalocyanine; a condensed polycyclic aromatic compound such as tetracene, chrysene, pentacene, pyrene, perylene and coronene; a conjugated polymer such as polyaniline, polythienylenevinylene, poly(3-hexylthiophene), poly(3-butylthiophene), poly(3-decylthiophene), poly(9,9-dioctylfluorene), poly(9,9-dioctylfluorene-co-benzothiazole) and poly(9,9-dioctylfluorene-co-dithiophene); an inorganic substance like silicon or the like; an oxide semiconductor; or the like, by an ink-jet method, a thermal vapor deposition method, a molecular ray epitaxy method, a spraying method, a spin coating method, a roll coating method, a blade coating method, a doctor roll method, a screen printing method, a nano-printing method, or the like.

FIG. 1 is a circuit diagram of an active matrix drive type display, and a drawing showing an example of a pixel plan view in the case where the semiconductor layer 109 is formed in parallel to the signal line 107′ and linearly.

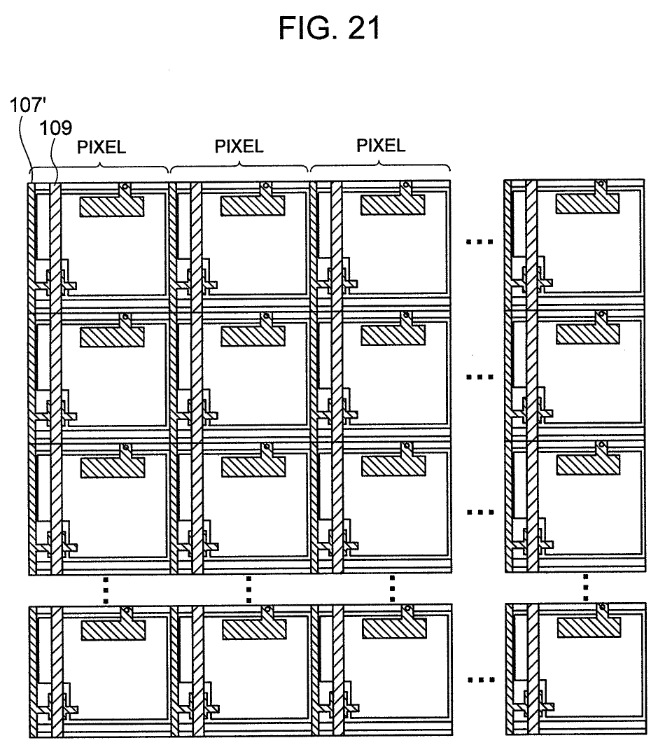

The active matrix drive type display has a plurality of signal lines 107′, a plurality of scanning lines 102′ arranged orthogonally to a plurality of signal lines 107′, a plurality of pixels enclosed by a plurality of signal lines and a plurality of scanning lines, and thin-film transistors arranged at each of a plurality of pixels, and has a plurality of pixels arranged in a matrix state (see FIG. 21). A plurality of the signal lines 107′ provide brightness signal (image data) to each of the pixels, and are controlled by being connected with the signal driver. A plurality of the scanning lines 102′ are connected with the scanning driver to control brightness signal transmitted from the signal lines 107′. This control provides a clock signal for switching a thin-film transistor connected with the signal lines and the scanning lines, from the scanning line, and executes switching control of the brightness signal and image display.

A detailed structure of the thin-film transistor will be described later, however, it is configured so as to have at least the insulating substrate 101, the gate electrode 102, the gate insulating film 105, the source electrode 106, the drain electrode 107 and the semiconductor layer 109.

In the case where a semiconductor is formed on a matrix, a multi-head nozzle having a plurality of nozzles is used. In this case, generation of clogging at even one nozzle requires replacement of all nozzles, which causes cost increase or throughput reduction. Therefore, prevention of nozzle clogging is one of the important objects in forming members by a coating method.

By using FIG. 1 of the present embodiment, one semiconductor layer 109 is commonly shared between pixels of one line, without being segmentalized on a pixel to pixel basis, as shown in FIG. 21, namely, it is formed over a plurality of pixels, and in parallel to the signal line and linearly. In this way, common sharing of the semiconductor layer 109 between pixels of one line is capable of continuously emitting a semiconductor solution from nozzles of a nozzle jet apparatus or an ink-jet apparatus, in rendering the semiconductor layer 109, which in turn is capable of preventing nozzle clogging caused by drying of the solution.

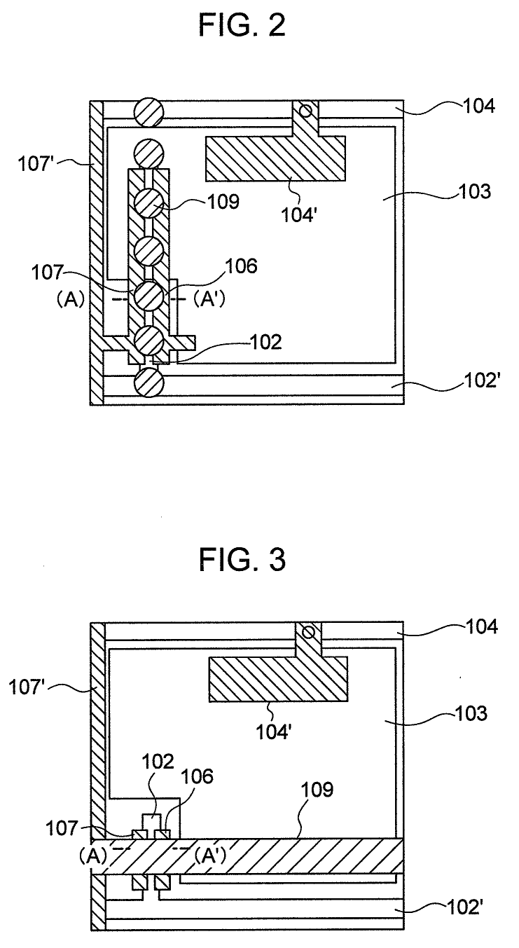

FIG. 2 is an example of forming the semiconductor layer 109 by continuously emitting the semiconductor solution using an ink-jet apparatus.

On the semiconductor layer 109, dots take a connected shape as shown by the drawing. This shape is obtained because conductive ink emitted from the head of the ink-jet spreads at wet condition in an isotropic direction while leaving dot shape mark in emission onto a substrate. On the semiconductor layer 109 in the drawing, dots are formed at a certain constant interval in a scanning direction of the ink-jet nozzle, namely in a parallel direction to a signal line in this case. FIG. 2 shows a separated state dot by dot, however, a linearly connected state in one line (linearly or in a meandering way) may be allowed. In the case where pixels are arranged parallel in a matrix way, as shown in FIG. 21, the semiconductor layer is formed, not linearly, so that those separated dot by dot are present over pixels, as shown in FIG. 2.

In addition, in the case of, for example, heating the insulating substrate 101 in formation of the semiconductor layer 109, the insulating substrate 101 expands. Therefore, formation of the semiconductor layer 109 by heating the insulating substrate 101 at 120° C. generates positional displacement caused by thermal expansion of the insulating substrate 101, and the displacement amount becomes larger in particular at the end part of the substrate than at the center of the substrate.

Therefore, for example, in the case where uniaxially drawn polyethylene terephthalate is used as the insulating substrate 101, each member such as an electrode or wiring or the like is arranged so that the semiconductor layer 109 is rendered in an orthogonal way to a drawing direction of the insulating substrate 101. The uniaxially drawn substrate becomes to have larger coefficient of thermal expansion in an orthogonal direction to a drawing direction as compared with in a drawing direction. Therefore, by rendering the semiconductor layer 109 in an orthogonal way to a drawing direction of the insulating substrate 101, thermal expansion of the substrate in an orthogonal direction to a rendering direction of the semiconductor layer 109 becomes small. On the other hand, although coefficient of thermal expansion of the substrate 101 in a rendering direction of the semiconductor layer 109 becomes large, it can be dealt with by providing allowance in length of the semiconductor layer 109. In this way, common sharing of the semiconductor layer 109 between pixels of one line by rendering in one linear line is also capable of reducing a problem of matching displacement caused by expansion and contraction of the substrate. It should be noted that the semiconductor layer 109 can also be segmentalized pixel by pixel, by laser, after being formed linearly.

FIG. 3 is an example of a pixel plan view in the case where the semiconductor layer 109 is formed in parallel to the scanning line 102′ and linearly. In this case, one semiconductor layer 109 is commonly shared between pixels of one row, without being segmentalized pixel by pixel, namely one semiconductor layer is formed over a plurality of pixels of one row, and in parallel to the scanning line 102′ (in perpendicular against the signal line 107′) and linearly. It should be noted that width of the semiconductor layer 109 may be any value as long as the layer is formed within a range of the source electrode 106 and the drain electrode 107.

In this way, common sharing of the linear semiconductor layer 109 between pixels of one row is capable of reducing cost and enhancing throughput due to prevention of nozzle clogging, and reducing a problem of matching displacement caused by expansion and contraction of the substrate, similarly as in the example of FIG. 1.

In addition, a semiconductor molecule in the semiconductor layer has characteristics of showing orientation in a rendering direction, which tends to make current flow easy in an orientation direction. As in FIG. 3, by forming the semiconductor layer 109 in parallel to a current route (channel) between the source electrode 106 and the drain electrode 107, an orientation direction of the semiconductor molecule becomes coincident with a channel direction, and thus higher mobility of electric field effect can be obtained.

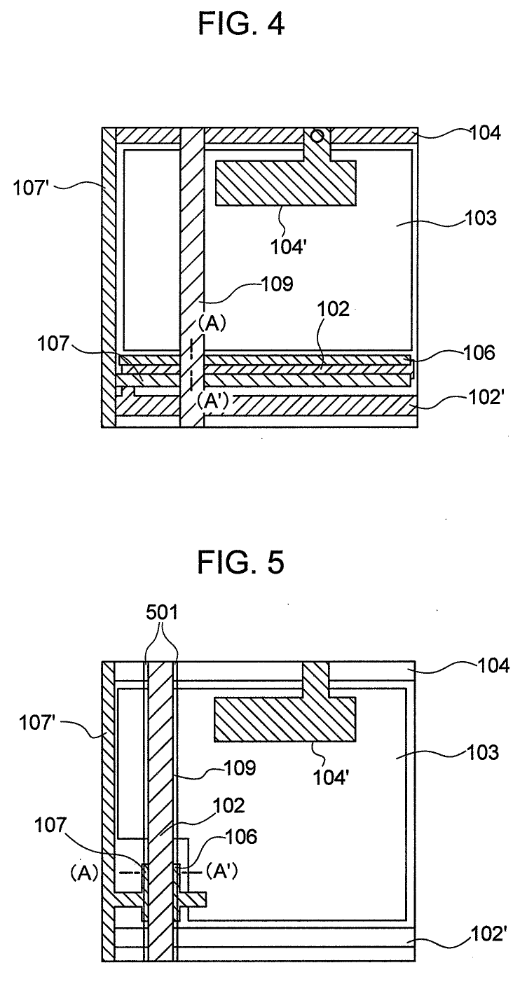

FIG. 4 is an example of a pixel plan view in the case where the source electrode 106 and the drain electrode 107 are formed longer in an orthogonal direction to a rendering direction of the semiconductor. In this way, by forming the source electrode 106 and the drain electrode 107 longer in an orthogonal direction to a rendering direction of the semiconductor, namely by forming the source electrode 106 and the drain electrode 107 linearly and longer in an orthogonal way to the semiconductor layer 109, compensation for matching displacement in an orthogonal direction to a rendering direction of the semiconductor can be increased, and thus a problem of matching displacement caused by expansion and contraction of the substrate can be reduced, even in the case where a biaxially drawn substrate, which isotropically expands and contracts, is used as the insulating substrate 101.

FIG. 5 is an example of a pixel plan view in the case where two partition walls (the partition wall layer 501) are formed, in advance, using polyimide having a thickness of 1 μm, by a nano-printing method, before formation of the semiconductor layer 109.

The two partition walls (the partition wall layer 501) have a configuration to be formed in a commonly shared way between a plurality of pixels of one row, and arranged in parallel to the signal line 107′ and linearly, similarly as one the semiconductor layer 109, namely, the semiconductor layer 109 is formed between the two partition walls (the partition wall layer 501). Such a configuration is capable of providing uniform line width of the semiconductor layer 109. In particular, as shown in an example of FIG. 4, it is effective to a structure where channel width of a TFT is determined by semiconductor width.

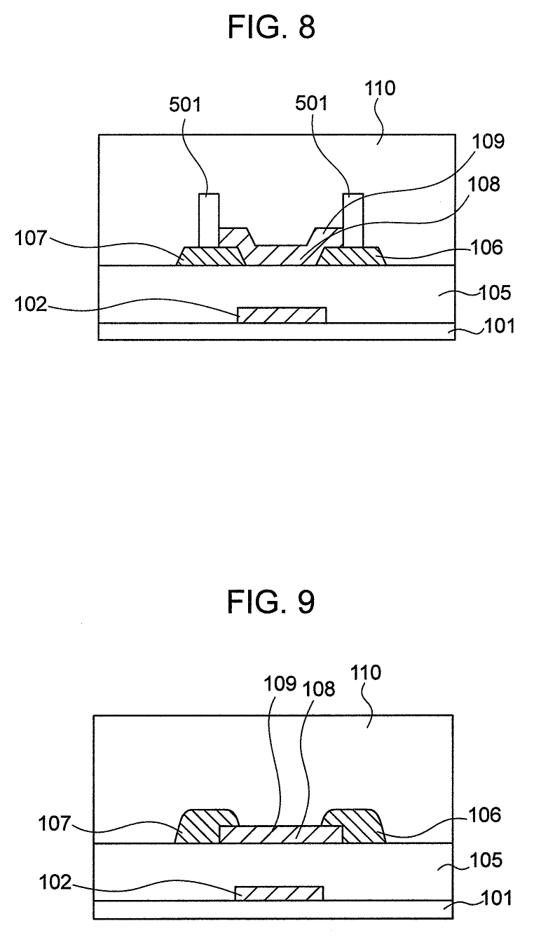

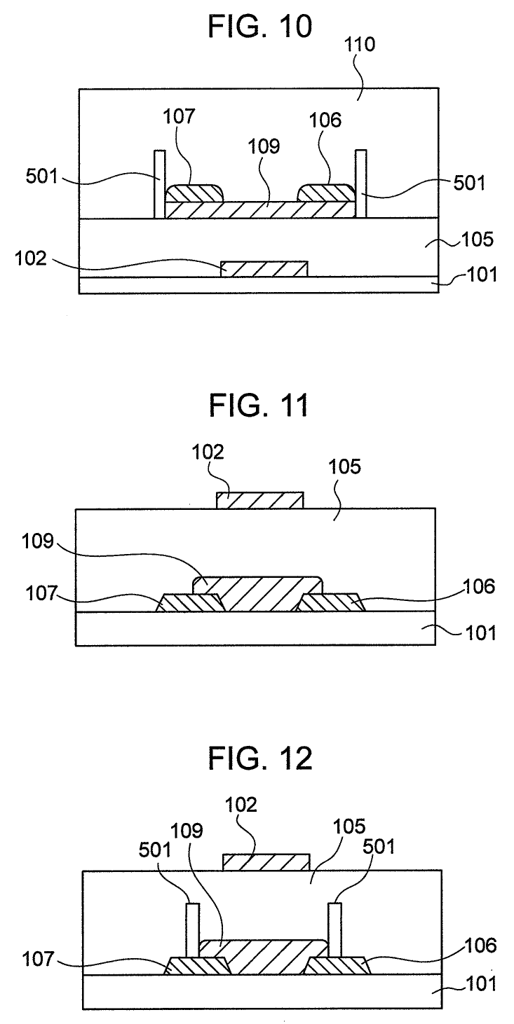

There are such cases that these partition walls (the partition wall layer 501) are formed onto the source electrode 106 and the drain electrode 107, and the semiconductor layer 109 is formed between them (FIG. 8, FIG. 12), or they are formed onto the gate insulating film 105, and the source electrode 106, the drain electrode 107 and the semiconductor layer 109 are formed between them (FIG. 10). The partition walls (the partition wall layer 501) can be formed using an organic film of such as polyvinylphenol, polyvinyl alcohol, polyamide, parylene, polymethylmethacrylate, polyvinyl chloride, polyacrylonitrile, poly(perfluoroethylene-co-butenyl vinyl ether), polyisobutylene, poly(4-methyl-1-pentene), poly(propylene-co-(1-butene)), a benzocyclobutene resin or the like, in addition to polyimide; a photosensitive material; a photosensitive self-assembled monolayer; an inorganic film of such as silicon nitride, aluminum oxide, tantalum oxide or the like; or a laminated film thereof, by a plasma CVD method, a thermal vapor deposition method, a sputtering method, an anodic oxidation method, a spraying method, a spin coating method, a roll coating method, a blade coating method, a doctor roll method, a screen printing method, a nano-printing method, an ink-jet method or the like.

Finally, a polysilazane solution was spin coated so as to cover the whole surface of the substrate, and subjected to modification to SiO₂ by firing at 120° C., to form the protecting film 110 with a thickness of 300 nm. The protecting film 110 can be formed using an inorganic film of like silicon nitride or the like without limiting to silicon oxide; an organic film of such as polyvinylphenol, polyvinyl alcohol, polyimide, polyamide, parylene, polymethylmethacrylate, polyvinyl chloride, polyacrylonitrile, poly(perfluoroethylene-co-butenyl vinyl ether), polyisobutylene, poly(4-methyl-1-pentene), poly(propylene-co-(1-butene)), a benzocyclobutene resin or the like; or a laminated film thereof, by a plasma CVD method, a thermal vapor deposition method, a sputtering method, an anodic oxidation method, a spraying method, a spin coating method, a roll coating method, a blade coating method, a doctor roll method, a screen printing method, a nano-printing method, an ink-jet method or the like.

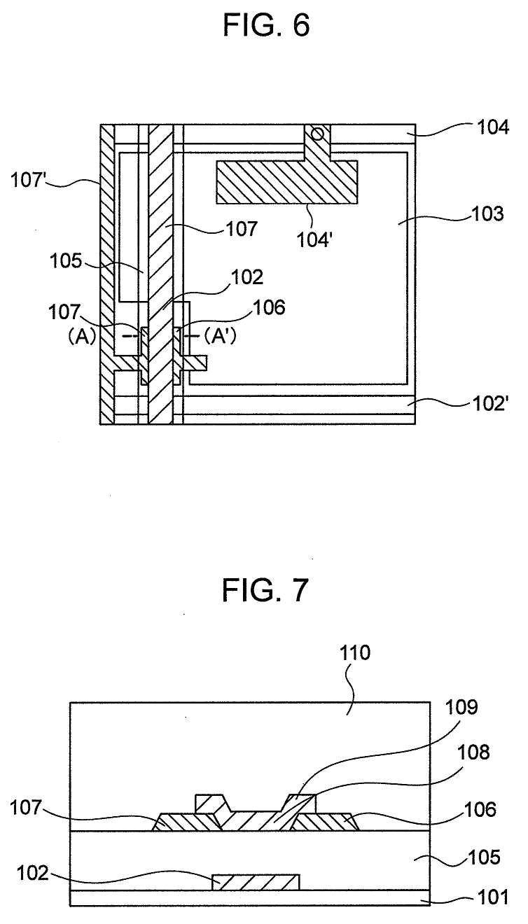

FIG. 6 is an example of a pixel plan view in the case where the gate insulating film 105 is formed, by a similar method as in the semiconductor layer 109, in parallel to the signal line 107′ and linearly, so that the gate insulating film 105 is commonly shared between pixels of each line. Formation of the gate insulating film 105 linearly in this way is capable of omitting a formation step of a contact hole at the pixel electrode 103, and thus enhancing throughput. In addition, the gate insulating film 105 may be formed, similarly as the semiconductor layer 109, in parallel to the scanning line 102′ and linearly, so that the gate insulating film 105 is commonly shared between pixels of each row. In these cases, it is desirable that capacity of, for example, liquid crystal to be driven or the like is adjusted, so that retaining capacity is not necessary to be formed.

FIG. 7 and FIG. 8 show schematic cross-sectional views of thin-film transistors using the present invention. FIG. 7 is a cross-section along (A)-(A′) in FIG. 1 and FIG. 2, while FIG. 8 is a cross-section along (A)-(A′) in FIG. 5.

In the present embodiment, a preparation method for a TFT where the gate electrode 102 is formed onto the substrate 101; the gate insulating film 105 is formed onto the gate electrode 102; the source electrode 106 and the gate electrode 107 are formed onto the gate insulating film 105; and the semiconductor layer 109 is formed between the source electrode 106 and the gate electrode 107 and lower part thereof, namely having a bottom-gate/bottom-contact structure arranged with the gate electrode 102, the source electrode 106 and the drain electrode 107 onto the lower layer of the semiconductor layer 109 was shown. However, the present invention can be applied, in addition to such a bottom-gate/bottom-contact structure, to a TFT, as shown in FIG. 9 and FIG. 10, where the gate electrode 102 is formed onto the substrate 101; the gate insulating film 105 is formed onto the gate electrode 102; the semiconductor layer 109 is formed onto the gate insulating film 105; and the source electrode 106 and the drain electrode 107 are formed onto the semiconductor layer 109, namely having a bottom-gate/top-contact structure arranged with the gate electrode 102 onto the lower layer of the semiconductor layer 109, and the source electrode 106 and the drain electrode 107 onto the upper layer of the semiconductor layer 109; or a TFT, as shown in FIG. 11 and FIG. 12, where the source electrode 106 and the drain electrode 107 are formed onto the insulating substrate 101; the semiconductor layer 109 is formed onto the source electrode 106 and the drain electrode 107; the gate insulating film 105 is formed onto the semiconductor layer; and the gate electrode 102 is formed onto the gate insulating film 105, namely having a top-gate/bottom-contact structure arranged with the gate electrode 102 onto the upper layer of the semiconductor layer 109, and the source electrode 106 and the drain electrode 107 onto the lower layer of the semiconductor layer 109.

It is possible to drive a liquid crystal element or an electrophoresis element or the like, using a TFT substrate prepared in this way.

### Embodiment 2

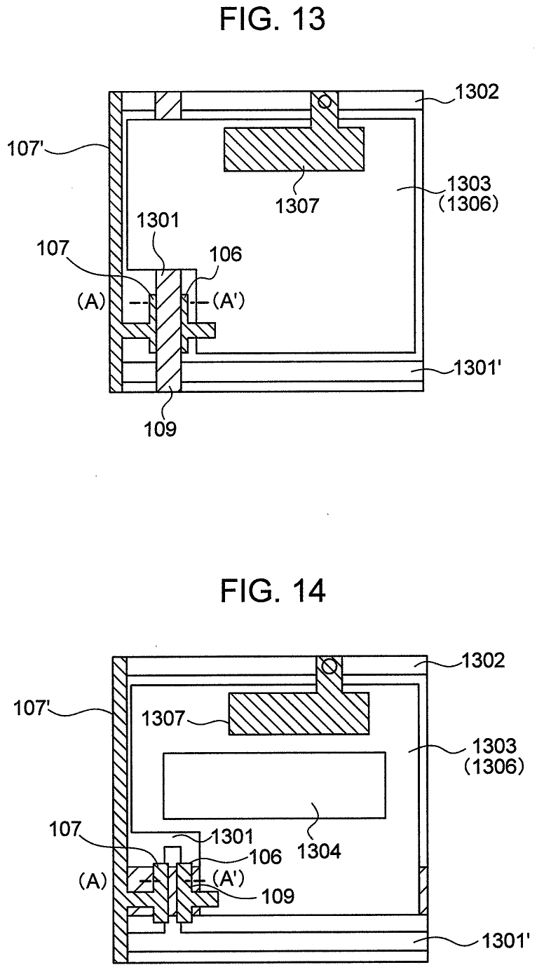

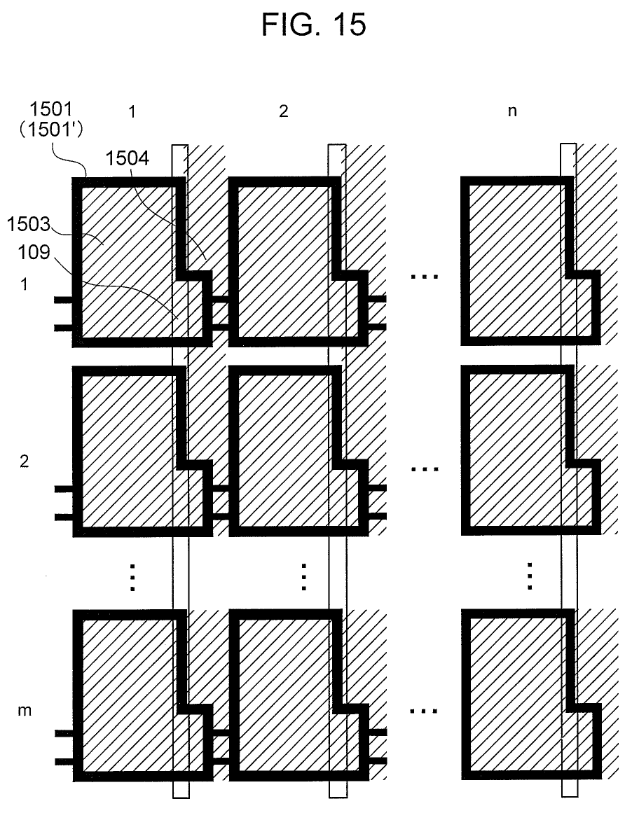

A second embodiment of the present invention will be explained with reference to FIG. 13 and FIG. 14.

The present embodiment has a bottom-gate/bottom-contact structure, similarly as Embodiment 1.

As the insulating substrate 101, a substrate made of polyethylene terephthalate provided with a barrier film of 100 nm thick SiO₂ at the both surfaces of the substrate was used. As the insulating substrate 101, any material can be selected from a wide range as long as it is an insulating material, similarly as in Embodiment 1. The gate electrode 1301 made of ITO, the scanning line 1301′, and the common wiring 1302 were formed thereon. The gate electrode 1301, the scanning line 1301′ and the common wiring 1302 are not especially limited as long as being transparent electric conductors, and IZO or the like may be used. Then, the pixel electrode 1303 with a thickness of 150 nm was formed using Al. The pixel electrode 1303 is not especially limited as long as an electric conductor that reflects light, and can be selected from a wide range, similarly as in Embodiment 1.

In addition, as in FIG. 14, it is also possible to form a semi-transmission pixel electrode by combination of an electric conductor that reflects light, and the transparent electrode 1304 using ITO or IZO. In this case, it is preferable that the gate electrode 1301, the scanning line 1301′ and the common wiring 1302 and the transparent electrode 1304 are simultaneously formed.

Then, an SiO₂ film with a thickness of 300 nm was formed by firing at 120° C., after spin coating of a polysilazane solution, and the SiO₂ films at a part on the common wiring 1302 and on the pixel electrode 1303 were removed to form the gate insulating film 105. As the gate insulating film 105, any material can be selected from a wide range as long as it is an insulating material, similarly as in Embodiment 1.

Then, the Au source electrode 106, the drain electrode 107, the signal line 107′ and the supporting electrode 1307 were formed in a thickness of 50 nm. The source electrode 106, the drain electrode 107, the signal line 107′ and the supporting electrode 1307 are not especially limited in a material and any one can be selected from a wide range as long as it is an electric conductor, and they can be formed by lamination thereof. Subsequently, by leaving them in the atmosphere, the naturally oxidized film 1305 with a thickness of 2 nm was formed onto the pixel electrode 1303.

Then, after coating, by a dip coating method, an alkyl fluoride-based silane coupling agent, represented by CF₃(CF₂)₇ (CH)₂SiCl₃, which is a liquid repellent mono-molecule having a carbon chain partially terminated with a fluorine group, the liquid repellent film 1306 was formed by exposing from the rear surface of the insulating substrate 101. Because the liquid repellent film 1306 is decomposed by light, it is formed only onto the pixel electrode 1303 that reflects light from the rear surface of the insulating substrate 101.

Then a soluble pentacene derivative was continuously coated with a nozzle jet apparatus so as to cross between pixel lines or rows, similarly as in Embodiment 1, and fired at 100° C. to form the semiconductor layer 109 with a thickness of 100 nm.

In this case, the liquid repellent film 1306 is formed onto the pixel electrode 1303 in the same pattern as on the pi electrode 1303. Subsequently, in coating and forming a semiconductor, the semiconductor is repelled from the upper part of the pixel electrode 1303 by the liquid repellent film 1306, and thus not adhered.

In this way, because the semiconductor solution is repelled from the gate insulating film 105 at the upper part of the pixel electrode 1303, by the liquid repellent film 1306, the semiconductor layer 109 is formed in segmentalized form by the liquid repellent film 1306. Segmentalization of the semiconductor layer 109 by the liquid repellent film 1306 is capable of preventing minute leak current between TFTs, which current flows via the semiconductor layer 109, and preventing cross talk between pixels.

It should be noted that the semiconductor layer 109 can be selected from a wide range as long as it is a semiconductor material, similarly as in Embodiment 1.

Finally, a polysilazane solution was spin coated so as to cover the whole surface of the substrate, and subjected to modification to SiO₂ by firing at 120° C., to form the protecting film 110 with a thickness of 300 nm. The protecting film 110 can be selected from a wide range as long as it is an insulating material, similarly as in Embodiment 1.

Also in the present Embodiment, in FIG. 13 shows, similarly as in the invention of FIG. 1, one semiconductor layer 109 has a configuration to be formed in a commonly shared way between a plurality of pixels of one row, and formed in parallel to the signal line 107′ and linearly, while in FIG. 14, similarly as in the invention of FIG. 3, one semiconductor layer 109 has a configuration to be formed in a commonly shared way between a plurality of pixels of one row, and formed in parallel to the scanning line and linearly

In addition, similarly as in Embodiment 1, by forming the source electrode 106 and the drain electrode 107 longer in an orthogonal direction to a rendering direction of the semiconductor, compensation for matching displacement in an orthogonal direction to a rendering direction of the semiconductor can be increased. In addition, by formation of partition walls (the partition wall layer 501), in advance, before formation of the semiconductor layer 109, line width of the semiconductor layer 109 can be made uniform. In addition, by formation of the gate insulating film 105 linearly, by a similar method as in the semiconductor layer 109, so that the gate insulating film 105 is commonly shared between pixels of each line or each row, a formation step of a contact hole at the pixel electrode part can be omitted, and thus throughput can also be enhanced. In addition, the present invention can be applied, not only to a bottom-gate/bottom-contact structure, but also to a TFT having a bottom-gate/top-contact structure, or a top-gate/bottom-contact structure.

It is possible to drive a liquid crystal element or an electrophoresis element or the like, using a TFT substrate prepared in this way.

Namely, by the addition of a characteristic configuration of Embodiment 1, both effects of Embodiment 1 and Embodiment 2 can be attained.

### Embodiment 3

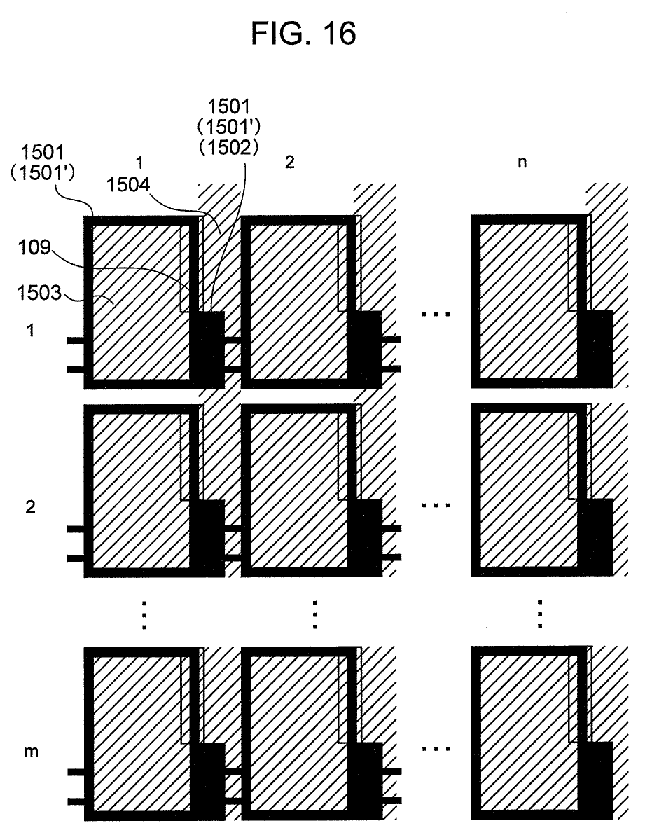

A third embodiment of the present invention will be explained with reference to FIG. 15 and FIG. 16.

As the insulating substrate 101, a quartz substrate was used. Then, by emitting a solution dispersed with copper nano-particles, using an ink-jet apparatus, the gate electrode 1501 with a thickness of 100 nm and the scanning line 1501′ were formed. As the gate electrode 1501 and the scanning line 1501′, any material, without limiting to copper, can be selected from a wide range, as long as it is an electric conductive material, similarly as in Embodiment 1.

Then, a SiO₂ film with a thickness of 300 nm was formed by firing at 120° C., after spin coating of a polysilazane solution, to form the gate insulating film 105. As the gate insulating film 105, one formed using, in addition to silicon oxide, silicon nitride (Si₃N₄), silicon oxynitride (SiON), aluminum oxide (Al₂O₃), zirconium oxide (ZrO₂), tantalum oxide (Ta₂O₅), or lanthanum oxide (La₂O₃), by a plasma chemical vapor deposition method or a sol-gel method may be used; in addition, a spin coated film of polyvinylphenol (PVP), polymethylmethacrylate (PMMA), as an organic material, may also be used. Then, after coating, by a dip coating method, an alkyl fluoride-based silane coupling agent, represented by CF₃(CF₂)₇ (CH)₂SiCl₃, which is a liquid repellent mono-molecule having a carbon chain partially terminated with a fluorine group, the liquid repellent film 1502 was formed by exposing from the rear surface of the insulating substrate 101. Because the liquid repellent film 1502 is decomposed by light, it is formed only onto the gate electrode 1501 that reflects light from the rear surface of the insulating substrate 101, and onto the gate insulating film 105 at the upper part of the scanning line 1501′.

Then, a solution dispersed with copper nano-particles was emitted and coated onto a hydrophilic region enclosed with the liquid repellent film 1502, using an ink-jet apparatus, and subsequently fired to form the source electrode (pixel electrode) 1503 and the signal line (drain electrode) 1504. As conductive ink, any material may be used, as long as being repelled from the liquid repellent region formed by a photosensitive liquid repellent film, having characteristics of wetting and spreading onto the liquid hydrophilic region where the photosensitive liquid repellent film is removed, and being a liquid material showing sufficiently low resistance value after firing; and specifically, a solution dispersed with metal super-fine particles or metal complexes with a diameter of 10 nm or smaller, of Au, Ag, Pd, Pt, Cu, Ni or the like, as main components, in a solvent such as water, toluene, xylene or the like, can be used. In addition, in formation of ITO (indium tin oxide) as a transparent electrode material, a solution dispersed with a metal alkoxide such as In(O-1-C₃H₇)₃ and Sn(O-i-C₃H₇)₃ or the like, in water or an alcohol solvent can be used. In addition, as a transparent electrode material other than this, an aqueous solution of PEDOT (poly-3,4-ethylenedioxythiophene) doped with PSS (polystyrenesulfonic acid) as a conducting polymer, polyaniline (PAn), polypyrrole (PPy) or the like can be used.

Then, after removing the liquid repellent film 1502 by exposure from the surface of the insulating substrate 101, a soluble pentacene derivative was continuously coated with a nozzle jet apparatus so as to cross between pixel lines, similarly as in Embodiment 1, and fired at 100° C. to form the semiconductor layer 109 with a thickness of 100 nm. The semiconductor layer 109 can be selected from a wide range as long as it is a semiconductor material, similarly as in Embodiment 1. The liquid repellent film 1502 can also be made to have selectivity of liquid repellency and lyophilicity, so as to have liquid repellency to a solution forming the source electrode (pixel electrode) 1503 and the signal line (drain electrode) 1504, but have lyophilicity to a solution forming the semiconductor layer 109. In this case, removal of the liquid repellent film 1502 is not necessary before forming the semiconductor layer 109. In addition, in the case where the liquid repellent film 1502 has liquid repellency also to a solution which forms the semiconductor layer 109, by continuous coating of a soluble pentacene derivative with a nozzle jet apparatus so as to cross between pixel lines, after removing the liquid repellent film 1502 by partial exposure from the surface of the insulating substrate 101, the semiconductor layer 109 is formed, as shown in FIG. 16, in a segmentalized form by the partially remained liquid repellent film 1502. Segmentalization of the semiconductor layer 109 by the liquid repellent film 1502 is capable of preventing minute leak current between TFTs, which current flows via the semiconductor layer 109, and preventing cross talk between pixels.

In the present embodiment, as shown in FIG. 15 and FIG. 16, the gate electrode 1501 (the scanning line 1501′) at the upper right part of a pixel is designed to have an L-shape hollow. In this hollow part, interval between adjacent pixels is made wide, which is capable of preventing junction between the semiconductor layer 109 and the source electrode (pixel electrode) 1503 of an adjacent pixel, even in the case where line width of the semiconductor layer 109 coated and formed is widened to some extent. This hollow is not limited to be L-shape, and any shape can be selected from a wide range, as long as junction between the semiconductor layer 109 and the source electrode (pixel electrode) of an adjacent pixel can be prevented, namely, the semiconductor layer 109 is not electrically connected with the source electrode (pixel electrode) of an adjacent pixel.

Finally, a polysilazane solution was spin coated so as to cover the whole surface of the substrate, and subjected to modification to SiO₂ by firing at 120° C., to form the protecting film 110 with a thickness of 300 nm. The protecting film 110 can be selected from a wide range as long as it is an insulating material, similarly as in Embodiment 1.

It is possible to drive a liquid crystal element or an electrophoresis display element or the like, using a TFT substrate prepared in this way.

### Embodiment 4

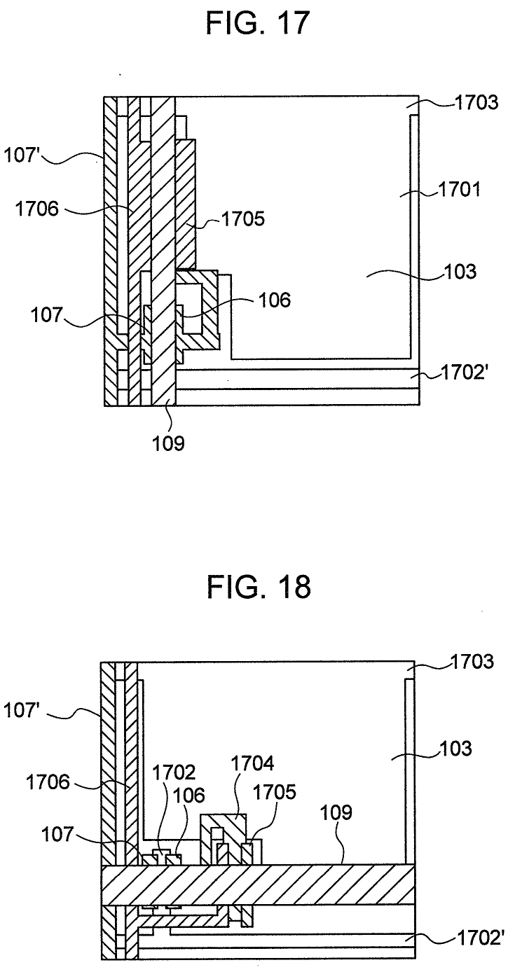

A fourth embodiment of the present invention will be explained with reference to FIG. 17 to FIG. 20. FIG. 17 to FIG. 20 show pixel plan views.

As the insulating substrate 101, a substrate made of polyethylene terephthalate provided with a barrier film of 100 nm thick SiO₂ at the both surfaces of the substrate was used. As the insulating substrate 101, any material can be selected from a wide range as long as it is an insulating material, similarly as in Embodiment 1. The lower IZO electrode 1701, the gate electrode 1702, the scanning line 1702′, and the earth line 1703 were formed thereon. The lower electrode 1701, the gate electrode 1702, the scanning line 1702′, and the earth line 1703 are not especially limited as long as being electric conductors, and can be selected from a wide range, similarly as in Embodiment 1.

Then, a SiO₂ film with a thickness of 300 nm was formed by firing at 120° C., after spin coating of a polysilazane solution, and the SiO₂ film on the lower electrode 1701 was removed to form the gate insulating film 105. As the gate insulating film 105, any material can be selected from a wide range as long as it is an insulating material, similarly as in Embodiment 1. In addition, by formation of the gate insulating film 105 linearly, by a similar method as in Embodiment 1, so that the gate insulating film 105 is commonly shared between pixels of each line or each row, a formation step of a contact hole at the pixel electrode part can be omitted, and thus throughput can also be enhanced.

Then, the Au source electrode 106, the drain electrode 107, the signal line 107′ and the second gate electrode 1704 were formed in a thickness of 50 nm. In this case, the signal line 107′ and the second gate electrode 1704 are mutually connected. A material of the source electrode 106, the drain electrode 107, the signal line 107′ and the second gate electrode 1704 is not especially limited and any one can be selected from a wide range as long as it is an electric conductor, and they can also be formed by lamination thereof.

Then a soluble pentacene derivative was continuously coated with a nozzle jet apparatus so as to cross between pixel lines or rows, similarly as in Embodiment 1, and fired at 100° C. to form the semiconductor layer 109 with a thickness of 100 nm. The semiconductor layer 109 can be selected from a wide range as long as it is a semiconductor material.

Then, an SiO₂ film with a thickness of 300 nm was formed by firing at 120° C., after spin coating of a polysilazane solution, and the SiO₂ film on the lower electrode 1701 was removed to form the second gate insulating film 105′. As the gate insulating film 105, any material can be selected from a wide range as long as it is an insulating material, similarly as in Embodiment 1. In addition, by formation of the gate insulating film 105 linearly, by a similar method as in Embodiment 1, so that the second gate insulating film 105′ is commonly shared between pixels of each line or each row, a formation step of a contact hole at the pixel electrode part can be omitted, and thus throughput can also be enhanced.

Then, a solution dispersed with gold nano-particles was emitted and coated, using an ink-jet apparatus, and subsequently fired to form the second source electrode 1705, the second drain electrode 1706 and the address line 1706′ to be connected to a lighting control power source. In this case, the lower part electrode 1701 and the second source electrode 1705 are connected. In addition, signal retaining capacity is formed between the lower part electrode 1701 and the second drain electrode 1706. As conductive ink, any material may be used, as long as being repelled from the liquid repellent region formed by a photosensitive liquid repellent film, having characteristics of wetting and spreading onto the liquid hydrophilic region where the photosensitive liquid repellent film is removed, and being a liquid material showing sufficiently low resistance value after firing; and as a specific material, a solution dispersed with metal super-fine particles or metal complexes with a diameter of 10 nm or smaller, of Au, Ag, Pd, Pt, Cu, Ni or the like, as main components, in a solvent such as water, toluene, xylene or the like, can be used. In addition, in formation of ITO (indium tin oxide) as a transparent electrode material, a solution dispersed with a metal alkoxide such as In(O-1-C₃H₇)₃ and Sn(O-1-C₃H₇)₃ or the like, in water or an alcohol solvent can be used. In addition, as a transparent electrode material other than this, an aqueous solution of PEDOT (poly(3,4-ethylenedioxythiophene)) doped with PSS (polystyrenesulfonic acid) as a conducting polymer, polyaniline (PAn), polypyrrole (PPy) or the like can be used. In addition, they can be formed by a known method such as a thermal vapor deposition method, a sputtering method, an electrolytic polymerization method, an electroless plating method, an electric plating method, a hot stamping method or the like, using not only a metal such as Al, Cu, Ti, Cr, Au, Ag, Ni, Pd, Pt, Ta or the like, but also a transparent electric conductor such as ITO and tin oxide, or an organic electric conductor such as polyaniline or poly(3,4-ethylenedioxythiophene)/polystyrenesulfonate. The above-described source electrode and the drain electrode may be used as not only a single layer structure but also a structure laminated with a plurality of layers. In addition, the second source electrode 1705, the second drain electrode 1706 and the address line 1706′ to be connected to a lighting control power source are fabricated to a desired shape using a photolithography method, a shadow mask method or the like.

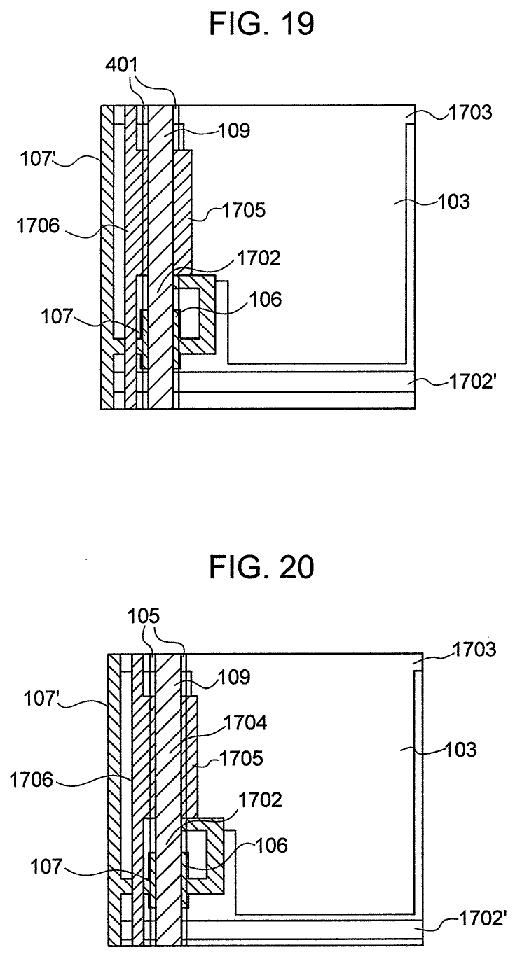

FIG. 17, FIG. 19, and FIG. 20 show, similarly as in FIG. 1 of Embodiment 1, one semiconductor layer has a configuration to be formed in a commonly shared way between a plurality of pixels of one row, and formed in parallel to the signal line and linearly

The present embodiment has two thin-film transistors (hereafter referred to as a TFT) in one pixel, so as to be designed to render the semiconductor 109 on one linear line by arrangement of the channel part of the two TFTs on a linear line. The present embodiment shows an example having two TFTs in one pixel, however, also in the case where 3 or more plurality of TFTs are present, the semiconductor 109 can be rendered on one linear line by arrangement of the channel part of each of the TFTs on a linear line.

It is possible to drive an OLED element, by providing a plurality of TFTs in one pixel.

Also in the present embodiment, similarly as in Embodiment 1, by forming the source electrode 106 and the drain electrode 107, and the second source electrode 1705 and the second drain electrode 1706 longer in an orthogonal direction to a rendering direction of the semiconductor, compensation for matching displacement in an orthogonal direction to a rendering direction of the semiconductor can be increased.

In addition, by formation of two partition walls 401 onto the source electrode and onto the drain electrode, or by formation of the semiconductor layer between the two partition walls 401, in advance, before formation of the semiconductor layer 109, similarly as in FIG. 5, FIG. 8 and FIG. 10 of Embodiment 1, line width of the semiconductor layer 109 can be made uniform.

It is possible to drive an organic electroluminescence device or the like, using a TFT substrate prepared in this way.

It should be further understood by those skilled in the art that although the foregoing description has been made on embodiments of the invention, the invention is not limited thereto and various changes and modifications may be made without departing from the spirit of the invention and the scope of the appended claims.

1. A display which is an active matrix type display comprising a plurality of signal lines, a plurality of scanning lines arranged orthogonally to said plurality of signal lines, a plurality of pixels enclosed by said plurality of signal lines and said plurality of scanning lines, and thin-film transistors arranged at each of said plurality of pixels, and a plurality of pixels arranged in a matrix state,
wherein said thin-film transistors have a substrate, a gate electrode, a gate insulating film, a source electrode and a drain electrode, and a semiconductor layer; and
said semiconductor layer is arranged over a plurality of pixels, and in parallel to said signal lines and linearly.

2. A display which is an active matrix type display comprising a plurality of signal lines, a plurality of scanning lines arranged orthogonally to said plurality of signal lines, a plurality of pixels enclosed by said plurality of signal lines and said plurality of scanning lines, and thin-film transistors arranged at each of said plurality of pixels, and a plurality of pixels arranged in a matrix state,
wherein said thin-film transistors have a substrate, a gate electrode, a gate insulating film, a source electrode and a drain electrode, and a semiconductor layer; and
said semiconductor layer is arranged over a plurality of pixels, and in parallel to said scanning lines and linearly.

3. The display according to claim 1, wherein said source electrode and said drain electrode are arranged in parallel to said scanning lines, and in perpendicular to said semiconductor layer and linearly.

4. A display which is an active matrix type display comprising a plurality of signal lines, a plurality of scanning lines arranged crosswise with said plurality of signal lines, a plurality of pixels enclosed by said plurality of signal lines and said plurality of scanning lines, and thin-film transistors arranged at each of said plurality of pixels, and a plurality of pixels arranged in a matrix state,
wherein said thin-film transistors have a substrate, a gate electrode, a gate insulating film, a source electrode and a drain electrode, and a semiconductor layer;
having two partition walls arranged onto each of said source electrode and said drain electrode or said gate insulating film, and arranged in parallel to said signal lines and linearly; and
said semiconductor layer is arranged between said two partition walls, over a plurality of pixels, and in parallel to said signal lines and linearly.

5. The display according to claim 1, wherein said gate insulating film is arranged in parallel to said semiconductor layer and linearly.

6. The display according to claim 1,
wherein said gate electrode is formed onto said substrate;
said gate insulating film is formed onto said gate electrode;
said source electrode and said gate electrode are formed onto said gate insulating film; and
said semiconductor layer is formed between said source electrode and said gate electrode.

7. The display according to claim 1,
wherein said gate electrode is formed onto said substrate;
said gate insulating film is formed onto said gate electrode;
said semiconductor layer is formed onto said gate insulating film; and
said source electrode and said gate electrode are formed onto said semiconductor layer.

8. The display according to claim 1,
wherein said source electrode and said gate electrode are formed onto said substrate; said semiconductor layer is formed onto said source electrode and said gate electrode;
said gate insulating film is formed onto said semiconductor layer; and
said gate electrode is formed onto said gate insulating film.

9. The display according to claim 4, wherein said two partition walls are formed by a photosensitive material.

10. The display according to claim 4, wherein said two partition walls are formed by a self-assembled monolayer.

11. The display according to claim 1, wherein said substrate of said thin-film transistor is an insulating substrate formed by polyethylene terephthalate.

12. The display according to claim 1,
wherein said substrate of said thin-film transistor is an insulating substrate formed by uniaxially drawn polyethylene terephthalate; and
said semiconductor layer is formed orthogonally to a drawing direction of said insulating substrate.

13. The display according to claim 1, wherein said semiconductor layer is electrically separated from the source electrode of adjacent pixels.

14. The display according to claim 1, wherein said thin-film transistors are arranged in plural in one pixel.

15. The display according to claim 1, wherein said semiconductor layer is formed by an organic material.
